(19) United States
(12) Patent Application Publication
(10) Pub. No.: US 2013/0260332 A1
(43) Pub. Date: Oct. 3, 2013

(54) Oral Hygiene Appliance

(71) Applicant: Michael Shapiro, Raynham, MA (US)

(72) Inventor: Michael Shapiro, Raynham, MA (US)

(21) Appl. No.: 13/800,008

(22) Filed: Mar. 13, 2013

Related U.S. Application Data
(60) Provisional application No. 61/616,590, filed on Mar. 28, 2012.

(51) Int. Cl. A61C 17/02

(52) U.S. Cl. CPC A61C 17/0211
USPC 433/80

(57) ABSTRACT

An oral hygiene appliance is provided having an upper and lower appliance member formed of an arcuate channel for placement over a wearer's upper and lower teeth and gum lines. The channels are comprised of an inner and outer layer sandwiching an internal pathway for routing a pressurized cleaning solution therethrough. The pathway is a network of tubules or a formed pathway between the channel layers, the pathway having a main conduit, branches, and outlets through the channel inner layers. The frontal portion of the appliance connects to at least one lead tube. The lead tubes further connect to an external fluid pump and reservoir of cleaning solution, which is pumped into the pathways of the upper and lower appliance and exit the outlets to spray remove plaque, tarter, and food particles. The device may be used in replacement of or in addition to traditional toothbrush cleaning routines.

### CROSS REFERENCE TO RELATED APPLICATION

This application claims the benefit of U.S. Provisional Application No. 61/616,590 filed on Mar. 28, 2012, entitled “Power Plaque Remover.” The above identified patent application is herein incorporated by reference in its entirety to provide continuity of disclosure.

### BACKGROUND OF THE INVENTION

1. Field of the Invention

The present invention relates to oral appliances, mouth guards, and dental hygiene devices. More specifically, the present invention pertains to an oral hygiene appliance that directs a pressurized cleaning solution into a user's mouth to remove plaque and food particles from the teeth and gums, wherein the solution is pressurized by a fluid pump and forced through a mouthpiece appliance having conduits that route the solution to targeted oral areas locations within the wearer's mouth.

Tooth brushing is an instrumental part of oral hygiene and an activity that should be attended to daily to ensure proper oral health and to avoid common oral maladies. Proper tooth brushing, however, relies primarily on the technique of the user. Therefore the effectiveness of the cleaning operation is largely reliant on how the user handles his or her toothbrush, what brushing technique is used, and the type of toothpaste dentifrice being utilized in the operation.

It is understood that poor dental hygiene, and more particularly poor brushing habits, can lead to various oral health issues related to the structure of one's teeth, gums, and tongue. After meals, food particles and tarter must be removed from the surface of teeth, from between teeth, and along areas of the gum therearound. Results of poor oral hygiene include plaque buildup, gum disease, and tooth decay, which can lead to greater health issues for the individual over time.

Proper brushing of one's teeth requires use of a tooth brush implement to clean the surfaces of each tooth and clean along the gum line to prevent or reduce such instances of these oral health problems. However, reliance on the individual and his or her brushing technique is not a robust way to ensure compliance and comprehensive cleaning. The food particles, tarter, plaque, and bacteria are removed from the surfaces of the mouth by abrasive contact and frictional removal. However, consistent and proper brushing relies on the user's training and discipline. In instances where the user is not using the appropriate brushing technique or not brushing thoroughly, areas of the mouth can remain untreated.

To ensure proper oral health, most will schedule professional teeth cleanings at a dental office, where a hygienist will perform tooth scaling and tooth polishing operations, and utilize a spray procedure to remove debris, plaque, and tarter. While this is the most effective means of cleaning one's teeth, most individuals frequent a professional dental office every six months, which makes the individual the primary means of maintain oral health over the long term.

The present invention pertains to a professional cleaning appliance that can be deployed individually, whereby the surfaces of the wearer's teeth and the gum line is cleaning using a pressurized spray directed at areas of the mouth. The device comprises a bi-laminar oral appliance resembling a mouthpiece, wherein a first and second channel is fitted over a wearer's upper and lower teeth. Within the bi-laminar construction of the upper and lower channel are conduits for routing a pressurized abrasive dentifrice solution, which exits the appliance and is directed to the surfaces of the teeth and the gingival margin to remove plaque, tarter, and bacteria from the areas of the teeth. Therefore, the individual's brushing technique is not relied upon for cleaning.

2. Description of the Prior Art

Devices have been disclosed in the prior art that relate to oral hygiene devices and oral appliances. These include devices that have been patented and published in patent application publications, and generally relate to mouthpiece oral appliances and oral spray cleaners. No devices are disclosed relating to a mouthpiece for directing a cleaning solution to targeted locations of a user's mouth. The following is a list of devices deemed most relevant to the present disclosure, which are herein described for the purposes of highlighting and differentiating the unique aspects of the present invention, and further highlighting the drawbacks existing in the prior art.

Specifically, U.S. Patent Application Publication No. 2009/0277461 to Gallagher, Jr. discloses an ingestible and masticatable oral appliance that comprises an upper and lower channel for forming around a wearer's teeth. Within the channels are integrally molded protrusions that act as brush bristles. The user inserts the appliance into his or her mouth, chews on the appliance until it becomes masticated material, and thereafter consumes the material. During the chewing operation, the protrusions disturb food particles and clean the wearer's teeth. The Gallagher device, while providing an oral appliance specifically suited for hygiene, discloses an edible structure that is consumed after each use, where physical structures are used to perform the cleaning operation. The present invention provides an appliance that directs a pressurized solution against the teeth and gum line for cleaning purposes. The structure and intent of the present invention diverge from that of Gallagher.

U.S. Patent Application Publication No. 2008/0280251 also to Gallagher, Jr. discloses a mouth guard appliance comprises a two inverted channels to accept the wearer's teeth therein. Disposed within the channels is a plurality of bristles that physically disturbs plaque and food particles, while a reservoir within the device allows for dentifrice to be added, allows the user to chew on the device and clean his or her teeth and gum line. This device similarly diverges from the present invention with respect to operation and operation. The present invention pertains to an oral appliance for subjecting the wearer's teeth and gingival margin to a pressurized solution for cleaning and washing operation, as opposed to a bristle contact cleaning operation.

Another such device is U.S. Pat. No. 4,059,101 to Richmond, which discloses a therapeutic oral appliance for massaging the gingival tissue of a user's mouth. The device comprises a mouthpiece article having curved channels and upstanding sidewalls. The sidewalls include a plurality of recesses to conform to the geometry of the user's teeth and adjacent areas, whereupon chewing on the device, the sidewalls flex inward against the crowns of the teeth and remove plaque and material therefrom. Similar to the Gallagher, Jr. devices, the Richmond deice is a frictional removal tool for oral hygiene purposes. The present invention utilizes a directed hygiene solution and a static structure positionable within a wearer's mouth, whereby the user does not chew on the device, but rather the solution is directed towards the gingival margin and tooth crown surfaces to remove plaque and food particles therefrom.

Other common oral hygiene devices in the art relate to cleaning, polishing, and plaque removal devices using a pressurized spray solution. These devices are generally handheld assemblies utilized by medical professionals and dental hygienists for professionally cleaning a patient's teeth. These provide excellent cleaning capabilities, but lack the ability to be individually used or utilized outside of a professional office. The present invention pertains to a personal hygiene device that utilizes a pressurized spray solution, whereby a mouthpiece appliance is placed over the wearer's teeth and the spray is injected thereinto and directed to targeted portions of the user's teeth. A single user can utilize the device on a regular basis and in the comfort of one's residence.

The present invention discloses a personal oral appliance that is utilized for teeth cleaning, whereby a pressurized solution is injected into the upper and lower appliance mouthpiece to direct the solution therethrough and towards targeted areas of each tooth within the individual's mouth for plaque, tarter, and bacteria removal. It is submitted that the present invention is substantially divergent in design elements from the prior art, and consequently it is clear that there is a need in the art for an improvement to existing oral hygiene appliances. In this regard the instant invention substantially fulfills these needs.

### SUMMARY OF THE INVENTION

In view of the foregoing disadvantages inherent in the known types of oral hygiene appliances now present in the prior art, the present invention provides a new appliance in the form of an upper and lower bi-laminar mouthpiece, wherein the same can be utilized for directing a dentifrice solution against the surfaces of each tooth and along the gum line for cleaning purposes.

It is therefore an object of the present invention to provide a new and improved oral hygiene appliance that has all of the advantages of the prior art and none of the disadvantages.

It is another object of the present invention to provide an oral hygiene appliance that includes an upper and lower mouthpiece that is conformal to the wearer's teeth, whereby a cleaning solution can be injected into the mouthpiece and directed against the surfaces of the wearer's teeth and gum lines.

Another object of the present invention is to provide an oral hygiene appliance that eliminates the need for manual tooth brushing, whereby cleaning of one's teeth and gums can be accomplished by inserting the disclosed oral appliance into the wearer's mouth and initiating a spray pump to draw solution from a reservoir and into the appliance for directed pressure washing application.

Yet another object of the present invention is to provide an oral hygiene appliance that comprises a first and second layer sandwiching an internal conduit of tubules or an internal pathway for which to route and direct a cleaning solution therethrough, whereby the spray exits the appliance at specific locations for cleaning each of the wearer's teeth and along the gum lines.

Another object of the present invention is to provide an oral hygiene appliance that can be molded for a particular user's mouth using an impression molding process, or alternatively a generic appliance can be provided that can be conformed after purchase or simply inserted into the user's mouth for general usage.

Another object of the present invention is to provide an oral hygiene appliance that includes a network of tubules or conduits through which a cleaning solution, such as an abrasive dentifrice solution, is forced therethrough towards the tubule/conduit outlets positioned adjacent to the surfaces of each tooth and along the gum line.

Another object of the present invention is to provide an oral hygiene appliance that can remove food particles, break up tarter, prevent plaque build-up, and remove germs within the mouth and between teeth that otherwise lead to oral hygiene and oral health issues.

Another object of the present invention is to provide an oral hygiene appliance that can be deployed personally, either at home or outside of the home, whereby the user does not require professional assistance or application for daily use.

Another object of the present invention is to provide an oral hygiene appliance that can be utilized daily in replacement or in addition to brushing operations for oral hygiene purposes.

Another object of the present invention is to provide an oral hygiene appliance that can be utilized in organizations or for individuals where compliance to oral hygiene standards and practices are required, such as in the military, or in situations where compliance in general is otherwise difficult, such as use with individuals having physical or mental handicaps.

Another object of the present invention is to provide an oral hygiene appliance that can be designed specifically for an individual user's mouth, wherein the geometry of his or her mouth, teeth, and gums can be accounted for, mapped, and then utilized to create a custom oral appliance that includes targeted areas of spray application appropriate for the individual.

Still yet another object of the present invention is to provide an oral hygiene appliance that can be constructed using a hard or soft compound, including different thermoplastic materials, acrylics, or other suitable material utilized in mouthguards, oral appliances, or the like.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top plan view of the upper oral appliance of the present invention.

FIG. 2 shows a cross section of the oral appliance channel, its construction, and its positioning relative to a molar.

FIG. 3 shows a cross section through the length of the oral appliance channel looking inward.

FIG. 4 shows a perspective view of the upper oral appliance of the present invention and its internal network of tubules.

FIG. 5 shows a cross section through the base oral appliance channel and through the network of tubules between the inner and outer appliance layers.

FIG. 6 shows a view of the upper and lower oral appliance in a working state, receiving pressurized oral dentifrice solution from lead tubes connected to a fluid pump and solution reservoir.

FIG. 7 shows one embodiment of the oral appliance construction, whereby the inner and outer oral appliance layers sandwich a network of tubules, the tubules penetrating the inner layer to direct the spray solution against the teeth and gums of a wearer.

FIG. 8 shows another embodiment of the oral appliance construction, whereby the inner and outer layers are connected and comprise complimenting halves of an internal pathway for which to direct the spray solution therethrough and against the teeth and gums of a wearer.

### DETAILED DESCRIPTION OF THE INVENTION

Reference is made herein to the attached drawings. Like reference numerals are used throughout the drawings to depict like or similar elements of the oral hygiene appliance. For the purposes of presenting a brief and clear description of the present invention, the preferred embodiment will be discussed as used for cleaning the surfaces of a wearer's teeth and cleaning the gum line using a directed spray solution. The figures are intended for representative purposes only and should not be considered to be limiting in any respect.

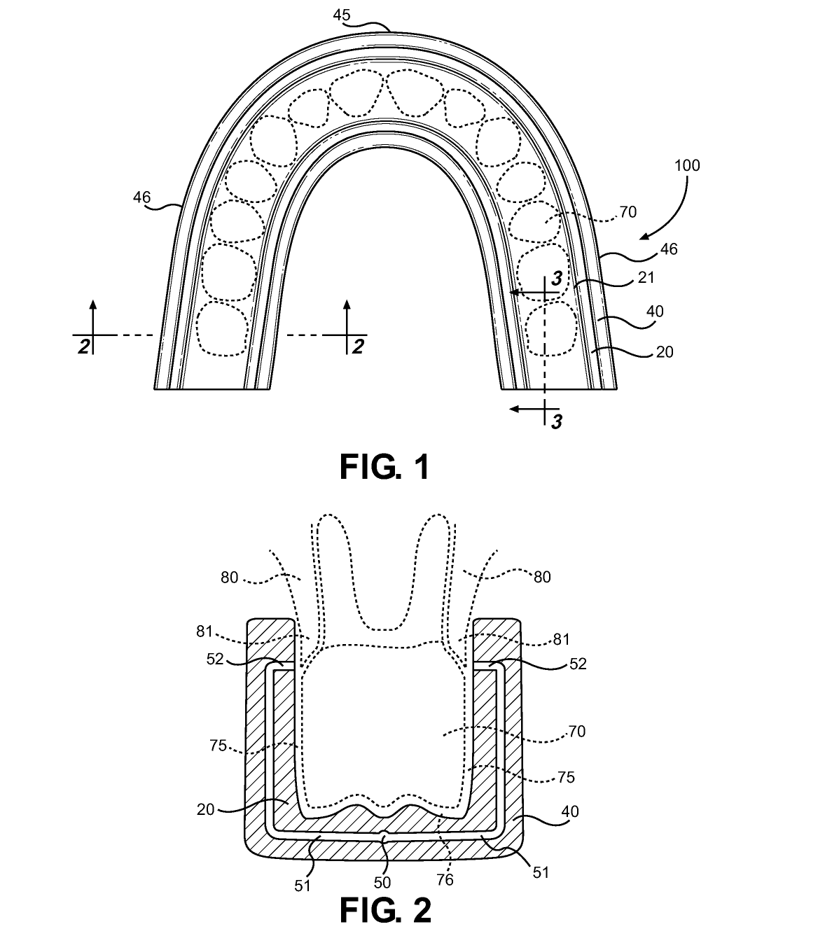

Referring now to FIG. 1, there is shown a top plan view of the upper oral appliance member 100 of the present invention. The present invention provides a custom-made or generic mouthpiece appliance having an upper and a lower appliance that is adapted to cover the wearer's teeth and gum line and position a plurality of tubule outlets adjacent to the teeth 70 surfaces, areas between teeth, and along the gum line. Within the upper and lower oral appliance is a network of fluid conduits or tubules that allowed a pressurized stream of cleaning solution to be routed through the appliance and directed outward onto the tooth and gum line surfaces within the wearer's mouth. The appliance is attached to a lead tube that secures to the upper and lower appliance to communicate the cleaning solution thereinto from a reservoir, wherein a fluid pump is the motive force to inject and distribute the solution within the appliances.

The upper 100 and lower oral appliances are comprise an inner 20 and outer 40 layer sandwiching the network of internal tubules that carrying the cleaning solution. The layers form a bi-laminar construction for the appliances, which are comprised of either a hardened material or a softer material, depending on application and preference of the user. The appliances themselves are curved structures having frontal portion 45 and two side portions 46 forming an arcuate, U-shaped channel that conforms to the curved pattern of a human bite. The channel of the upper and lower appliance accepts the crown of the user's teeth 70 and overlaps a portion of the gum line near the gingival margin. The interior surface 21 of the inner appliance layer 20 can be molded to form closely to the user's particularly teeth geometry or be less conformal thereto; however, the channel interior surface 21 is adapted to cover the crown of each tooth 70 and provide positioning of the tubule outlets therearound and along the gum line for food particle, plaque, and tarter removal.

Referring now to FIG. 2, there is shown a cross section cut across the width of the upper appliance channel along its side portion, wherein the channel is conforming around a molar tooth 70. As shown, the channel comprises a pair of upstanding walls and a base surface forming a U-shaped channel within which a wearer's teeth 70 are positioned. The channel length is an arcuate pathway following the general shape of a wearer's bite pattern. This arraignment is well known in the art of mouthguards and other oral appliances having a channel configuration.

The structure of the channel base and upstanding walls is that of a mated inner 20 and outer 40 layer that sandwich an inner tubule network or an inner open pathway for the pressurized cleaning solution. The two layers are coextensive with one another and are preferably permanently affixed together during construction of the appliance. As visualized in FIG. 2, the inner tubule network comprises a main conduit 50 spanning the length of the arcuate channel and routed along the base thereof. At given locations, tubule or pathway branches 51 extend from the main conduit 50 to route the solution to an outlet 52 location along the crown of the tooth 20 or along the gum line 81 of the user's gums 80. The channel extends over the gingival margin 81 and over a portion of the gums 80, while the inner layer 20 is positioned adjacent to or in contact with the tooth crown.

The tubule or pathway branches 51 communicate the cleaning solution (dentifrice, abrasive, or other oral hygiene solution) away from the main conduit 50 and into the walls of the channel to specific locations. The locations can be designed specifically for the user, whereby the outlets 52 are strategically positioned against tooth surfaces 75, in between teeth, and along the gum line. When the solution is communicated into the appliance, the solution enters the main conduit 50 and is routed into its branches 51 and is ejected from the outlets 52. These outlets 52 function as orifices or nozzles for spraying the pressurized solution against the tooth 70 and gum 80 surfaces to remove food particles, tarter, and plaque therefrom. The outlets 52 extend through the inner layer 20 to its inner surface, allowing the free communication of fluid through the inner layer 20 and into the interior of the U-shaped channel.

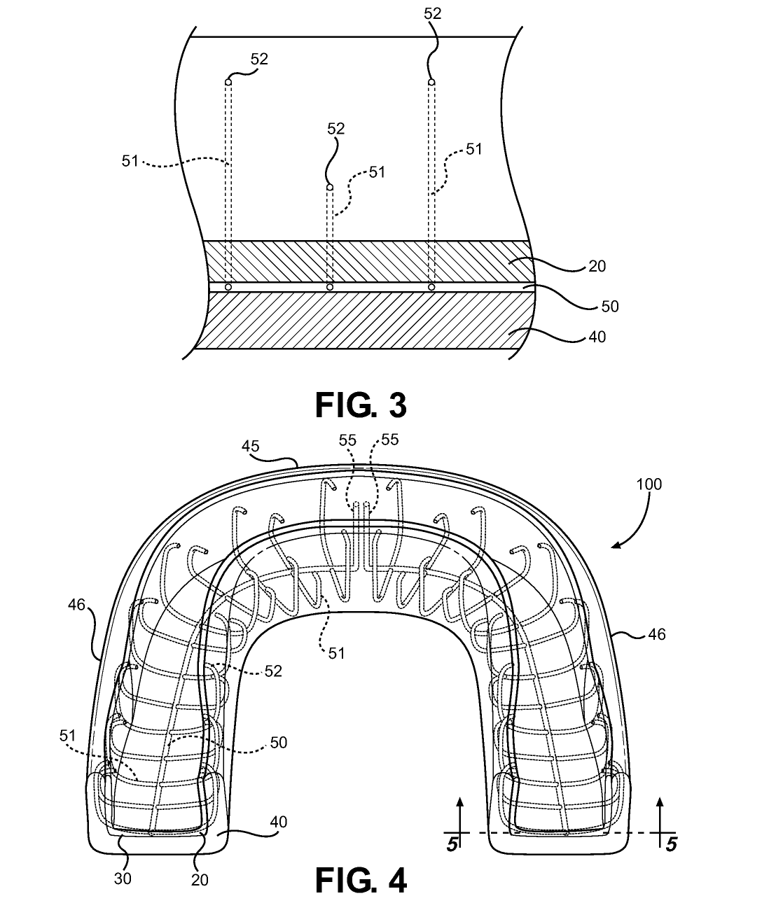

Referring now to FIG. 3, there is shown a lengthwise section cut along the interior of the appliance channel side portion, whereby the base of the channel is sectioned and the upstanding wall and the tubule outlets 52 are visualized. In this view, the base of the channel comprising of the outer layer 40, inner layer 20 and tubule main conduit 50 is shown. A pressurized oral hygiene or abrasive oral cleaning solution is communicated into the main conduit 50 between the layers of the appliance and into the tubule or pathway branches 51. These branches 51 extend along the base and upwards into the upstanding walls of the channel between the layers. The branches 51 can further extend directly upward through the inner layer to communicate the solution onto the upper crown surface of a tooth or between teeth thereabove.

The extent or distance to which the branches 51 extend along the sides of the channel is dependent on its location along the channel length. The branches 51 extend into the sidewalls to the point in which the outlet 52 is positioned, and therefore to the extent with which the spray is necessary in that given location. In some areas it is more advantageous to position outlets 52 higher or lower along the sidewall of the channel, depending on whether a tooth is present at that location or if a gap between teeth is present. Gaps between teeth and application of the solution along the gum line will require greater branch 51 lengths to position the outlets 52 away from the upper surface of the tooth and in the appropriate position to apply the solution in those locations. Application directly against the sides of the tooth may require shorter branch lengths.

It is contemplated that the present appliance be either custom made for a dental patient or generically deployed. In the former, a dental professional can map out the best locations for the outlets depending on the specific geometry of the individual's mouth, taking into account the user's bite, his or her teeth geometry, relative positioning, and gum line structure. These locations are predetermined and can be defined as the outlet 52 locations for which the custom appliance will be built. If such an exercise is not required or not desired, a generic appliance with estimated placement of the outlets can be designed, whereby the locations are based on the average mouth geometry for a given overall size.

Referring now to FIG. 4, there is shown a perspective view of the upper oral appliance 100 of the present invention, wherein the tubule/pathway network is positioned between the inner 20 and outer 40 layers of the appliance. At least one conduit inlet 55 is positioned along the frontal portion 45 of the device, which connects to a corresponding fluid tube that communicates the cleaning solution into the appliance from an external reservoir and fluid pump. Once within the inlet 55, the solution enters the main conduit 50 along the side portions 46 of the appliance and into the individual branches 51 before exiting each of the outlets 52 and into the wearer's mouth. The pathway or tubule network is therefore an open pathway to communicate pressurized fluid from an external source, directing a high pressure spray against the surfaces of the wearer's teeth and gum line. The tubule network terminates along the ends 30 of the appliance to maintain pressure and to ensure the outlets 52 are the only means of exhausting the solution from the appliance.

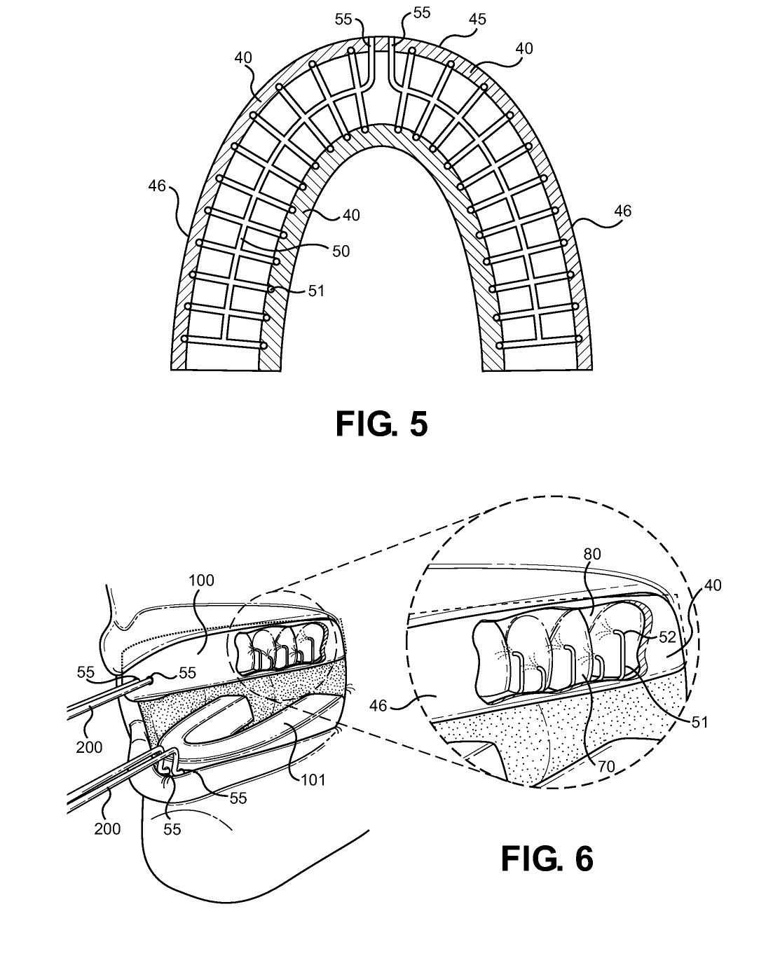

Referring now to FIG. 5, there is shown a cross section through the base of the appliance channel and through the tubule network therein. In this view, the outer layer 40 is shown in a cut view and supporting the tubule main conduit 50 and its branches 51, which extend between the inner and outer 40 layers and directly through the inner layer to eject the solution from the appliance along the frontal 45 and side portions 46 of the appliance. The solution inlets 55 are positioned along the frontal portion 45 of the appliance to allow for hookup of lead tubes to a solution reservoir and fluid pump.

Referring now to FIG. 6, there is shown a view of the upper 100 and lower 101 oral appliance of the present invention in a working state, positioned over the upper and lower teeth of a wearer and projecting an oral cleaning solution against the surfaces of each tooth 70 and along the gum line 80. In operation, the user places the upper 100 and lower 101 appliance over his or her upper and lower bite. Thereafter, lead tubes 200 are connected to the appliance inlets 55 of each appliance, wherein each appliance includes at least one inlet 55. The lead tubes 200 are connected to a fluid pump and solution reservoir. When the pump is energized, the solution is pressurized and communicated through the feed tubes 200, into the upper and lower appliance inlets 55 and into each of the tubule main conduits, branches 51, and through the outlets 52. The solution is ejected from the outlets 52 with sufficient velocity to break up food particles, hardened tarter, and plaque from teeth 70, therebetween and along the gum line 80. In FIG. 6, the call-out showing the side portion 46 of the upper appliance shows the outlets 52 ejecting the solution from the tubule network.

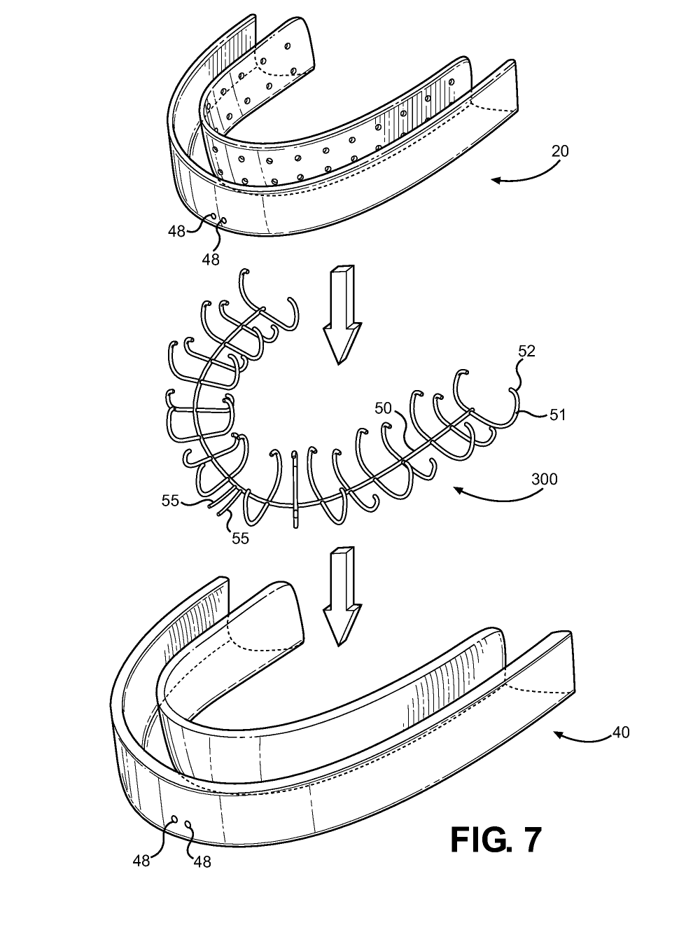

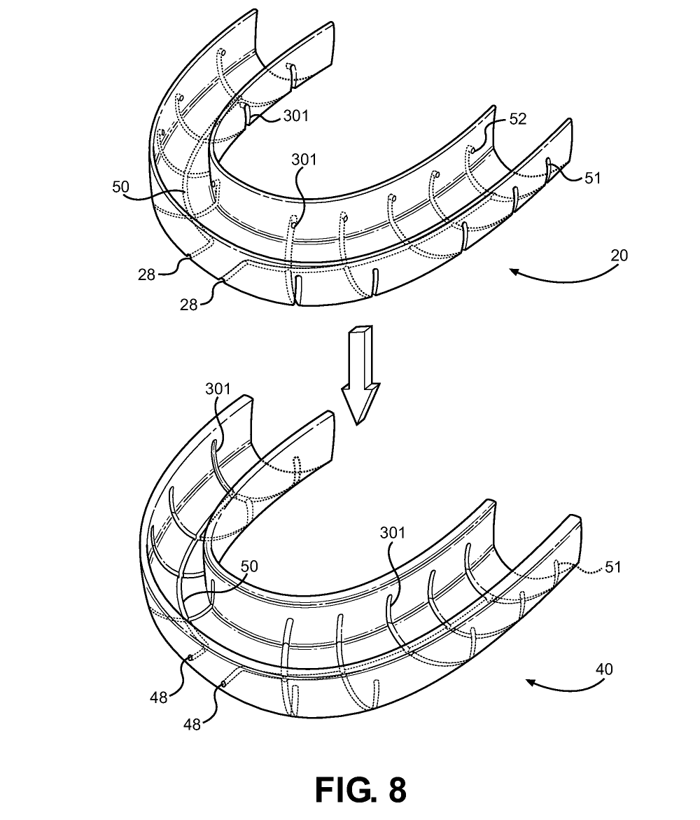

Referring now to FIGS. 7 and 8, there are shown two contemplated constructions of the present oral hygiene appliance. As shown in FIG. 7, a first contemplated construction comprises a defined tubule network 300 comprised of an interconnected series of tubes that define the main conduit 50, its branches 51, and the tubule outlets 52. Once defined, the tubule network 300 is sandwiched between the appliance outer layer 40 and inner layer 20, whereby the inner layer comprises apertures 48 along its surface to allow for the outlets 52 and inlets 55 to be positioned therethrough for proper communication of fluid.

In a second contemplated construction and as visualized in FIG. 8, the tubule network is replaced by an internal series of pathways between the inner layer 30 and the outer layer 40. Along the interface between the inner and outer layer, each layer incorporates a corresponding half 301 of the defined pathway, such that when joined, the halves establish a defined pathway for fluid to enter into the appliance by way of the inlet apertures 48 and distribute throughout the pathway main conduit 50, branches 51, and outlets 52. Alternatively, one of the layers could be formed to contribute the defined pathway while the other is uniform across its interface surface. The inner and outer layers secure together via adhesive bonding or similar material adhesion, whereby the two layers are permanently secured together and form a defined pathway for fluid with no leakage outside of the pathway conduit 50 and branches 51 extending therefrom.

Overall, the present invention describes an oral hygiene appliance that is inserted into the user's mouth and over his or her teeth to remove plaque and tarter therefrom. A network of fluid pathways established by tubules or formed pathways project a cleaning or abrasive solution to different areas of the mouth, including the surfaces of the teeth and along the gum line. The appliance is connected to a fluid pump that pressurizes a solution and forces it through the appliance in a continuous or intermittent manner. The pumped solution can be a number of different dental cleaning agents, including different dentifrice solutions or abrasives solution for pressure washing away plaque and tarter. The pressure from the pump, as well as the abrasive cleaner, act to remove plaque, tarter, and bacteria from the teeth and gums of a wearer.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An oral hygiene appliance, comprising:
an arcuate appliance member having a base and upstanding walls forming an elongated channel having a channel interior for accepting a row of teeth therein;
said channel comprising an inner layer and an outer layer coextensive with one another;
a fluid pathway positioned between said inner layer and said outer layer for communicating fluid therethrough;
said pathway having a main conduit, a plurality of conduit branches extending from said main conduit, and a plurality of conduit branch outlets;
said conduit branches positioned between said inner layer and said outer layer;
said conduit outlets extending through said inner layer to communicate fluid from said conduit branch and into said channel interior;
at least one a conduit inlet for injecting fluid into said fluid pathway.

2) The oral appliance of claim 1, wherein said fluid pathway further comprises a tubule network for communicating fluid therethrough.

3) The oral appliance of claim 1, wherein said fluid pathway further comprises a pathway formed between said inner layer and outer layer.

4) The oral appliance of claim 1, further comprising at least one lead tube for connection to said at least one fluid pathway inlet, said lead tube being connected to a fluid reservoir and fluid pump for forcing pressurized fluid into said appliance fluid pathway.

5) The oral appliance of claim 1, wherein said channel interior is adapted to accept a bottom row of a user's teeth.

6) The oral appliance of claim 1, wherein said channel interior is adapted to accept a top row of a user's teeth.

7) The oral appliance of claim 1, wherein said plurality of conduit branch outlets are positioned along a user's teeth to project a pressurized fluid against the tooth crown, between teeth, and along the gum line.
